(19) United States
(12) Patent Application Publication
(10) Pub. No.: US 2016/0358591 A1
(43) Pub. Date: Dec. 8, 2016

(54) TIMING CONTROLLER OF DISPLAY APPARATUS AND OPERATION METHOD THEREOF

(71) Applicant: AU OPTRONICS CORP., Hsin-Chu (TW)

(72) Inventors: Yen-Hsu Chou, Hsin-Chu (TW); Wan-Ling Cheng, Hsin-Chu (TW); Fang-Yi Lin, Hsin-Chu (TW)

(21) Appl. No.: 14/828,670

(22) Filed: Aug. 18, 2015

(30) Foreign Application Priority Data
Jun. 3, 2015 (TW) 104118026

(51) Int. Cl. G09G 5/393

(52) U.S. Cl. CPC G09G 5/393; G09G 2310/08; G09G 2360/12

(57) ABSTRACT

A timing controller of a display apparatus is provided. The timing controller timing controller includes a processing unit and a memory unit. The processing unit is configured to receive external display data and a control signal. The external display data includes a plurality of images. The memory unit is electrically coupled to the processing unit and an external memory unit storing with a plurality of optical lookup table. The memory unit is configured to store with one of the plurality of optical lookup table according to the control signal received by the processing unit and output optical data corresponding to a currently-displaying image in the optical lookup table stored in the memory unit. The memory capacity of the memory unit is less than that of the external memory unit. An operation method for the timing controller is also provided.

### TECHNICAL FIELD

The present disclosure relates to a timing controller, and more particularly to a timing controller with a smaller memory capacity of a display apparatus.

### BACKGROUND

Generally, liquid crystal display apparatus includes a timing controller, a data driver and a gate driver. Timing controller is configured to provide a specific timing and display data to data driver and gate driver. Thus, gate drive can drive pixels to receive the display data according to the timing and data driver can provide the display data to the pixels for displaying according to the timing. To display images properly, a conventional timing controller needs to store all the possible display data, such as the related display data in two-dimensional or three-dimensional modes each time when the liquid crystal display apparatus is powered on. In order to store all the possible display data, the timing controller may need a memory with a certain memory capacity. However, a memory with a certain memory capacity may also mean a relatively large hardware size. In addition, in order to store all the possible display data each time when the liquid crystal display apparatus is powered on, the timing controller may need a longer data storing time, the liquid crystal display apparatus may have an increasing power-on time and consequentially a user may have a poor using experience.

### SUMMARY

The present disclosure provides a timing controller of a display apparatus. The timing controller includes a processing unit and a memory unit. The processing unit is configured to receive external display data and a control signal. The external display data includes a plurality of images. The memory unit is electrically coupled to the processing unit and an external memory unit storing with a plurality of optical lookup table. The memory unit is configured to store with one of the plurality of optical lookup table according to the control signal received by the processing unit and output optical data corresponding to a currently-displaying image in the optical lookup table stored in the memory unit. The memory capacity of the memory unit is less than that of the external memory unit.

The present disclosure further provides an operation method for the aforementioned timing controller. The operation method includes: configuring the memory unit to store with one of the plurality of optical lookup table according to the control signal; and configuring the memory unit, when the processing unit receives the external display data, to output optical data corresponding to a currently-displaying image in the optical lookup table stored in the memory unit.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic view of a display apparatus in accordance with an embodiment of the present disclosure;

FIG. 2 is a block diagram of a timing controller in accordance with an embodiment of the present disclosure;

FIG. 3A is a schematic view of an external memory unit in accordance with an embodiment of the present disclosure;

FIG. 3B is a schematic timing sequence for illustrating an operation of a timing controller in accordance with an embodiment of the present disclosure;

FIG. 3C is a schematic view of a memory unit corresponding to the timing sequence of FIG. 3B in accordance with an embodiment of the present disclosure;

FIG. 3D is another schematic view of a memory unit corresponding to the timing sequence of FIG. 3B in accordance with an embodiment of the present disclosure;

FIG. 3E is a schematic timing sequence for illustrating an operation of a timing controller in accordance with another embodiment of the present disclosure;

FIG. 4A is a schematic view of a display panel in accordance with an embodiment of the present disclosure;

FIG. 4B is a schematic view of an external memory unit in accordance with another embodiment of the present disclosure;

FIG. 4C is a schematic timing sequence for illustrating an operation of a timing controller in accordance with still another embodiment of the present disclosure;

FIG. 4D is a schematic view of a memory unit corresponding to the timing sequence of FIG. 4C in accordance with an embodiment of the present disclosure;

FIG. 4E is another schematic view of a memory unit corresponding to the timing sequence of FIG. 4C in accordance with an embodiment of the present disclosure;

FIG. 5 is a block diagram of a timing controller in accordance with another embodiment of the present disclosure;

FIG. 6 is a flow chart of an operation method of a timing controller in accordance with an embodiment of the present disclosure; and

FIG. 7 is a flow chart of an operation method of a timing controller in accordance with another embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

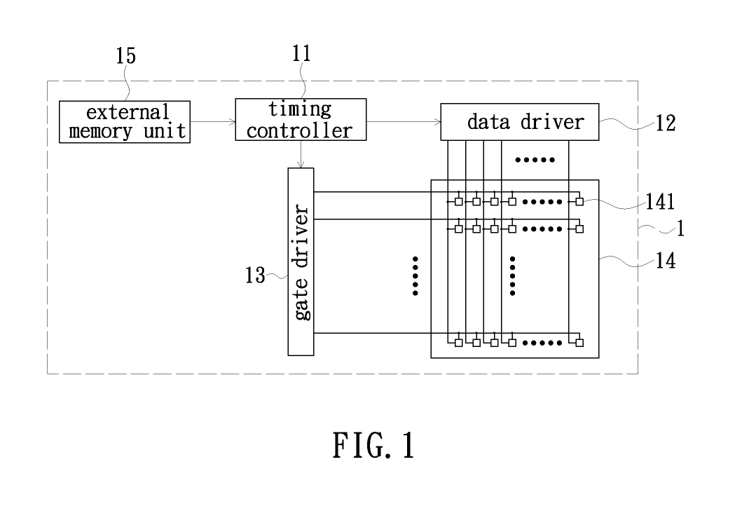

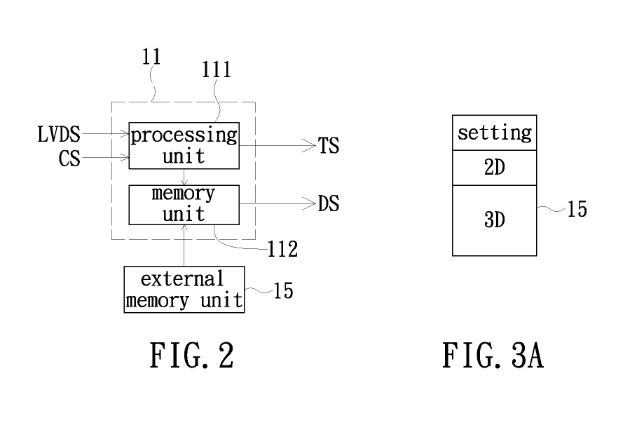

Please refer to FIG. 1, which is a schematic view of a display apparatus 1 in accordance with an embodiment of the present disclosure. As shown in FIG. 1, the display apparatus 1 in the present embodiment includes a timing controller 11, an external memory unit 15, a display panel 14, a data driver 12 and a gate driver 13. The display panel 14 includes a plurality of pixel 141. The timing controller 11 is electrically coupled to the external memory unit 15, the data driver 12 and the gate driver 13. The timing controller 11 is configured to provide a timing signal TS (FIG. 2) for an operation of the display apparatus 1 and optical data DS (FIG. 2) for image displaying to the data driver 12 and the gate driver 13. The data driver 12 and the gate driver 13 are further electrically coupled to the plurality of pixel 141. Each pixel 141 is configured to be turned on/off through a control of the gate driver 13, receive the optical data DS outputted from the data driver 12, and display the optical data DS at specific time.

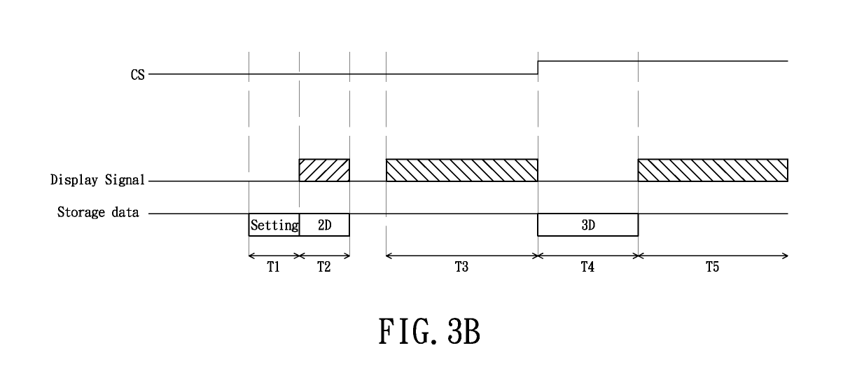

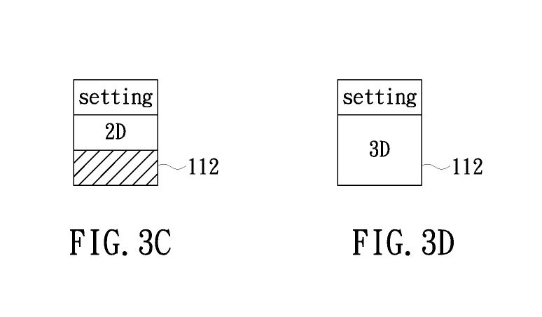

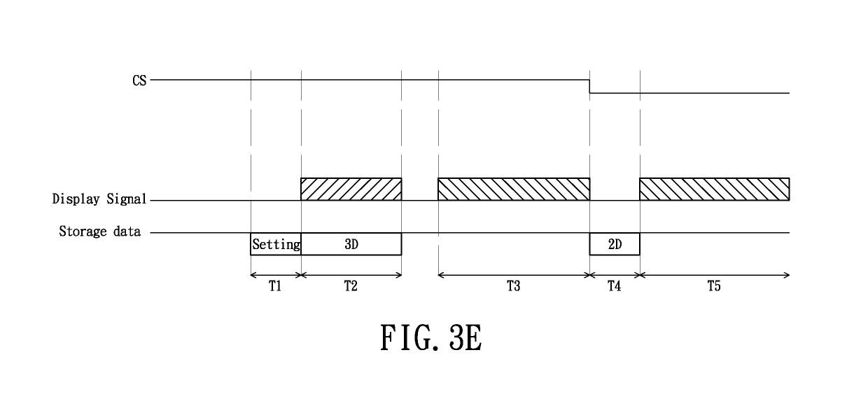

Please refer to FIG. 2, which is a block diagram of the timing controller 11 in accordance with an embodiment of the present disclosure. As shown in FIG. 2, the timing controller 11 in the present embodiment includes a processing unit 111 and a memory unit 112. The processing unit 111 is electrically coupled to the memory unit 112. The processing unit 111 is configured to receive external display data LVDS to be displayed and a control signal CS and control the memory unit 112 to store specific data according to the control signal CS. The processing unit 111 is further configured to generate and output the timing signal TS. The external display data LVDS includes a plurality of image. The memory unit 112 is further electrically coupled to the external memory unit 15. The external memory unit 15 is configured to store with a plurality of optical lookup table and setting data setting (FIG. 3) for a power-on of the display apparatus 1. In one embodiment, the external memory unit 15 may be a memory such as an electrically erasable programming read-only memory or a flash memory. The memory unit 112 is configured to store with the setting data setting while the display apparatus 1 is being power-on and store with one of the plurality of optical lookup table in the external memory unit 15 according to the control signal CS received by the processing unit 111. In addition, the memory unit 112 is further configured to output the optical data DS corresponding to a currently-displaying image in the stored optical lookup table to the data driver 12. The memory capacity of the memory unit 112 is less than that of the external memory unit 15. In one embodiment, the memory unit 112 may be a memory such as a synchronous dynamic random access memory, a static random access memory or a dynamic random access memory.

Please refer to FIG. 3A, which is a schematic view of the external memory unit 15 in accordance with an embodiment of the present disclosure. As shown in FIG. 3A, beside storing with the setting data setting for the power-on of the display apparatus 1, the external memory unit 15 further stores with a two-dimensional optical lookup table 2D for a two-dimensional image displaying and a three-dimensional optical lookup table 3D for a three-dimensional image displaying. It is to be noted that the memory capacity for the three-dimensional optical lookup table 3D is greater than that for the two-dimensional optical lookup table 2D. FIG. 3B is a schematic timing sequence for illustrating an operation of the timing controller 11 in accordance with an embodiment of the present disclosure. In FIG. 3B, CS denotes the control signal CS; Display Signal denotes the currently-displaying image; and Storage Data denotes the content stored in the memory unit 112. First, at time T1, the display apparatus 1 is converted from a power-off state to a power-on state. Thus, the setting data setting is automatically downloaded from the external memory unit 15 to the memory unit 112. In addition, because the display apparatus 1 is initially power-on and has not received the external display data LVDS to be displayed yet, the memory unit 112 just receiving the setting data setting automatically outputs the optical data DS corresponding to a black image to the electrically-coupled data driver 12. Then, at time T2, the display apparatus 1 displays a black image to avoid abnormal displaying situation. Meanwhile when the display apparatus 1 displays the black image at time T2, the processing unit 111 controls the memory unit 112 to store with the corresponding optical lookup table in the external memory unit 15 according to the content of the control signal CS. In this exemplary embodiment as illustrated in FIG. 3B, the control signal CS has a low level at time T2, thus, the processing unit 111 is configured to control the memory unit 112 to store with the two-dimensional optical lookup table 2D from the external memory unit 15 according to the low-level control signal CS, as illustrated in FIG. 3C. Consequentially, when the processing unit 111 receives the external display data LVDS, the memory unit 112 outputs the optical data DS corresponding to the currently-displaying image in the two-dimensional optical lookup table 2D, so that the data driver 12 can display the optical data DS at time T3, as illustrated in FIG. 3B.

Next, please refer to FIG. 3B. First, at time T4 (between two successive images), the control signal CS is converted to have a high level at time T2, thus, the processing unit 111 is configured to control the memory unit 112 to store with the three-dimensional optical lookup table 3D from the external memory unit 15 according to the high-level control signal CS, as illustrated in FIG. 3D. Consequentially, the memory unit 112 outputs the optical data DS corresponding to the currently-displaying image in the three-dimensional optical lookup table 3D, so that the data driver 12 can display the optical data DS at time T5, as illustrated in FIG. 3B. In the present embodiment, because the processing unit 111 can control the memory unit 112 to store with the corresponding optical lookup table at any time according to the content of the control signal CS, the memory unit 112 does not need to store with all the optical lookup tables when the display apparatus 1 is being powered on. Accordingly, the memory unit 112 only requires a memory capacity equal to or greater than the data amount of the setting data setting plus the data amount of the three-dimensional optical lookup table 3D. In other words, the memory unit 112 only needs a memory capacity equal to or greater than the data amount of the optical lookup table with the maximum data amount plus the data amount of the setting data setting. In addition, the display apparatus 1 does not need to wait the memory unit 112 to store with all the optical lookup tables from the external memory unit 15 and then starts to display the external display data LVDS. Thus, the display apparatus 1 can be powered on more quickly and users can have better using experiences. Please refer to FIG. 3E, which is a schematic timing sequence for illustrating an operation of the timing controller 11 in accordance with another embodiment of the present disclosure. As shown, the main difference between FIGS. 3E and 3B is that the control signal CS in FIG. 3E has a high level at time T2, thus, the memory unit 112 stores with the three-dimensional optical lookup table 3D first when the display apparatus 1 displays a black image at time T2. At time T4, the control signal CS in FIG. 3E is converted to have a low level, thus, the memory unit 112 then stores with the two-dimensional optical lookup table 2D.

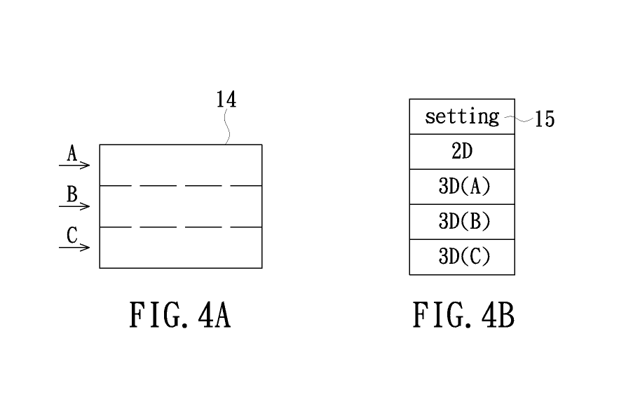

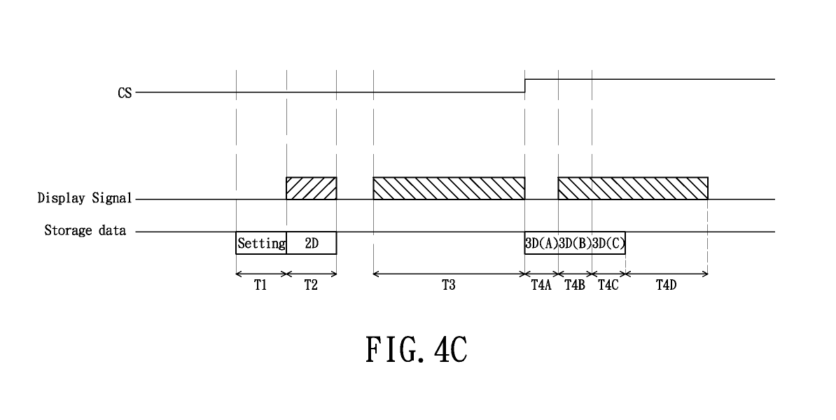

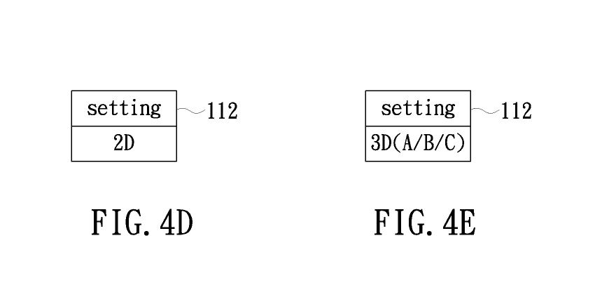

Next, please refer to FIGS. 4A and 4B. Because partition overdrive function can be used to drive the pixels 141 of the display panel 14 when the three-dimensional display is performed, the display panel 14 can be exemplarily divided into three partitions A, B and C, which correspond to a first sub-three-dimensional optical lookup table 3D(A), a second sub-three-dimensional optical lookup table 3D(B) and a third sub-three-dimensional optical lookup table 3D(C) applied to the partition overdrive function. In the present embodiment as illustrated in FIG. 4B, beside storing with the setting data setting and the two-dimensional optical lookup table 2D, the external memory unit 15 further stores with the first sub-three-dimensional optical lookup table 3D(A), the second sub-three-dimensional optical lookup table 3D(B) and the third sub-three-dimensional optical lookup table 3D(C). In one embodiment, the data amount of the two-dimensional optical lookup table 2D is equal to that of each one of the first sub-three-dimensional optical lookup table 3D(A), the second sub-three-dimensional optical lookup table 3D(B) and the third sub-three-dimensional optical lookup table 3D(C).

FIG. 4C is a schematic timing sequence for illustrating an operation of the timing controller 11 in accordance with another embodiment of the present disclosure. Please refer to FIG. 4C first. In FIG. 4C, CS denotes the control signal CS; Display Signal denotes the currently-displaying image; and Storage Data denotes the content stored in the memory unit 112. First, at time T1, the display apparatus 1 is converted from a power-off state to a power-on state. Thus, the setting data setting is automatically downloaded from the external memory unit 15 to the memory unit 112. In addition, because the display apparatus 1 is initially power-on and has not received the external display data LVDS to be displayed yet, the memory unit 112 just receiving the setting data setting automatically outputs the optical data DS corresponding to a black image to the electrically-coupled data driver 12. Then, at time T2, the display apparatus 1 displays a black image to avoid abnormal displaying situation. Meanwhile when the display apparatus 1 displays the black image at time T2, the processing unit 111 controls the memory unit 112 to store with the corresponding optical lookup table in the external memory unit 15 according to the content of the control signal CS. In this exemplary embodiment as illustrated in FIG. 4C, the control signal CS has a low level at time T2, thus, the processing unit 111 is configured to control the memory unit 112 to store with the two-dimensional optical lookup table 2D from the external memory unit 15 according to the low-level control signal CS, as illustrated in FIG. 4D. Consequentially, when the processing unit 111 receives the external display data LVDS, the memory unit 112 outputs the optical data DS corresponding to the currently-displaying image in the two-dimensional optical lookup table 2D, so that the data driver 12 can display the optical data DS at time T3.

Next, please refer to FIG. 4C. At time T4A, the control signal CS is converted to have a high level, thus, the processing unit 111 controls the memory unit 112 to store with the three-dimensional optical lookup table 3D. In the present embodiment, the three-dimensional optical lookup table 3D is exemplarily divided into the first sub-three-dimensional optical lookup table 3D(A), the second sub-three-dimensional optical lookup table 3D(B) and the third sub-three-dimensional optical lookup table 3D(C) according to the display region. Thus, specifically, the memory unit 112 may store with the first sub-three-dimensional optical lookup table 3D(A) first at time T4A; then, at time T4B, the memory unit 112 outputs the optical data DS corresponding to the partition A of the currently-displaying image in the first sub-three-dimensional optical lookup table 3D(A) and stores with the second sub-three-dimensional optical lookup table 3D(B); then, at time T4C, the memory unit 112 outputs the optical data DS corresponding to the partition B of the currently-displaying image in the second sub-three-dimensional optical lookup table 3D(B) and stores with the third sub-three-dimensional optical lookup table 3D(C); and then, at time T4D, the memory unit 112 outputs the optical data DS corresponding to the partition C of the currently-displaying image in the third sub-three-dimensional optical lookup table 3D(C), thereby completing the displaying of the currently-displaying image.

In the present embodiment, the data amount of the two-dimensional optical lookup table 2D is equal to that of each one of the first sub-three-dimensional optical lookup table 3D(A), the second sub-three-dimensional optical lookup table 3D(B) and the third sub-three-dimensional optical lookup table 3D(C). Accordingly, the memory unit 112 only requires a memory capacity equal to or greater than the data amount of the setting data setting plus the data amount of the two-dimensional optical lookup table 2D. In other words, the memory unit 112 only needs a memory capacity equal to or greater than the data amount of any one of the optical lookup tables in the external memory unit 15 plus the data amount of the setting data setting. Thus, the needed memory capacity of the memory unit 112 is significantly reduced. In addition, the display apparatus 1 does not need to wait the memory unit 112 to store with all the optical lookup tables from the external memory unit 15 and then starts to display the external display data LVDS. Thus, the display apparatus 1 can be powered on more quickly and users can have better using experiences.

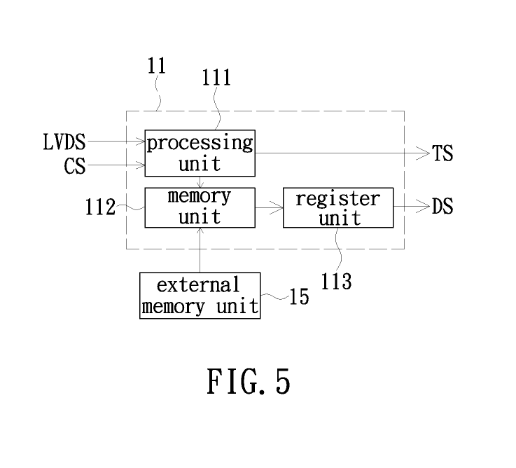

In other embodiments, the timing controller 11 may further include a register unit 113 as shown in FIG. 5. The register unit 113 is electrically coupled to the memory unit 112 and the data driver 12. The register unit 113 is configured to temporarily stores with the optical data DS outputted from the memory unit 112 and then output the optical data DS to the data driver 12.

In other embodiments, the external memory unit 15 may further have optical lookup tables of some different modes such as a normal display mode, a movie display mode or a dynamic display mode.

In other embodiments, the external memory unit 15 may further have optical lookup tables of some different displaying frequencies such as 60 Hz, 120 Hz or 240 Hz.

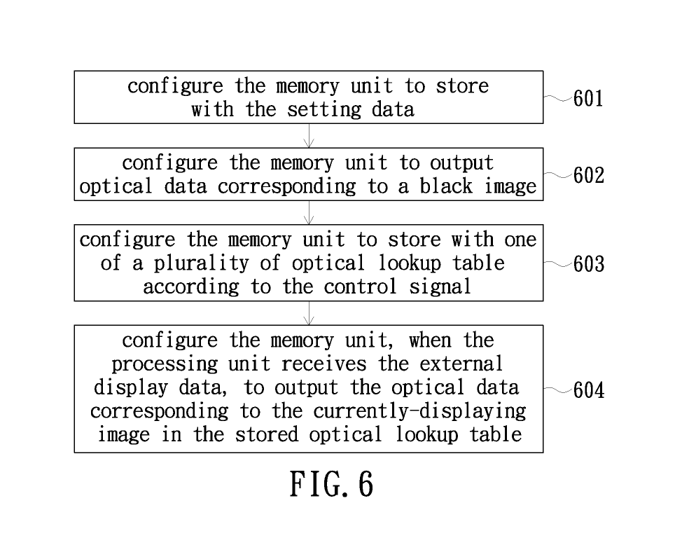

According to the aforementioned description, an operation method for the timing controller 11 is obtained as shown in FIG. 6, which is a flow chart of an operation method of the timing controller 11 in accordance with an embodiment of the present disclosure. As shown in FIG. 6, the operation method in the present embodiment includes steps of: configure the memory unit 112 to store with the setting data setting when the display apparatus 1 is converted from a power-off state to a power-on state (step 601); configure the memory unit 112 to output optical data DS corresponding to a black image according to the setting data setting (step 602); configure the processing unit 111 to control the memory unit 112 to store with one of a plurality of optical lookup table according to the control signal CS (step 603); and configure the memory unit 112, when the processing unit 111 receives the external display data LVDS, to output the optical data DS corresponding to the currently-displaying image in the stored optical lookup table to the electrically-coupled data driver 12 (step 604).

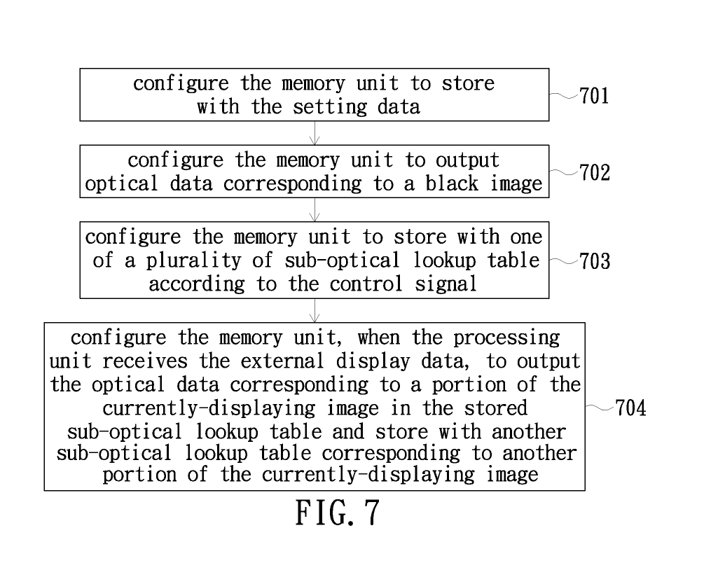

FIG. 7 is a flow chart of an operation method of the timing controller 11 in accordance with another embodiment of the present disclosure, wherein the optical lookup table includes a plurality of sub-optical lookup tables in the present embodiment. As shown in FIG. 7, the operation method in the present embodiment includes steps of: configure the memory unit 112 to store with the setting data setting when the display apparatus 1 is converted from a power-off state to a power-on state (step 701); configure the memory unit 112 to output optical data DS corresponding to a black image according to the setting data setting (step 702); configure the processing unit 111 to control the memory unit 112 to store with one of a plurality of sub-optical lookup table according to the control signal CS (step 703); and configure the memory unit 112, when the processing unit 111 receives the external display data LVDS, to output the optical data DS corresponding to a portion of the currently-displaying image in the stored sub-optical lookup table to the electrically-coupled data driver 12 and store with another sub-optical lookup table corresponding to another portion of the currently-displaying image (step 704).

In summary, by only storing the required optical lookup table or sub-optical lookup table of the currently-displaying image, the memory capacity of the memory unit in the timing controller of the present disclosure is significantly reduced, the hardware size of the memory unit is reduced, the time for storing the optical lookup table is reduced, and the time for power on the display apparatus is reduced. In other words, the timing controller of the present disclosure can reduce the hardware cost and improve the using experiences.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A timing controller of a display apparatus, the timing controller comprising:
a processing unit, configured to receive external display data and a control signal, wherein the external display data comprises a plurality of images; and
a memory unit, electrically coupled to the processing unit and an external memory unit storing with a plurality of optical lookup table, the memory unit being configured to store with one of the plurality of optical lookup table according to the control signal received by the processing unit and output optical data corresponding to a currently-displaying image in the optical lookup table stored in the memory unit, wherein a memory capacity of the memory unit is less than that of the external memory unit.

2. The timing controller according to claim 1, wherein the external memory unit further stores with setting data.

3. The timing controller according to claim 1, wherein the memory capacity of the memory unit is equal to or greater than a sum of data amounts of the setting data and the one in the plurality of optical lookup table having the maximum data amount.

4. The timing controller according to claim 2, wherein the plurality of optical lookup table comprise a plurality of sub-optical lookup table.

5. The timing controller according to claim 4, wherein the memory unit is further configured to store with one of the plurality of sub-optical lookup table according to the control signal received by the processing unit and store with another sub-optical lookup table corresponding to a second portion of the currently-displaying image when output the optical data corresponding to a first portion of the currently-displaying image in the stored sub-optical lookup table.

6. The timing controller according to claim 5, wherein the memory capacity of the memory unit is equal to or greater than a sum of data amounts of the setting data and the one in the plurality of sub-optical lookup table having the maximum data amount.

7. The timing controller according to claim 1, wherein the memory unit is a synchronous dynamic random access memory, a static random access memory or a dynamic random access memory.

8. The timing controller according to claim 1, wherein the external memory unit is an electrically erasable programming read-only memory or a flash memory.

9. An operation method for a timing controller of a display apparatus, the timing controller comprising a processing unit and a memory unit, the processing unit being configured to receive external display data and a control signal, the external display data comprising a plurality of images, the memory unit being electrically coupled to the processing unit and an external memory unit storing with a plurality of optical lookup table, a memory capacity of the memory unit is less than that of the external memory unit, the operation method comprising:
configuring the memory unit to store with one of the plurality of optical lookup table according to the control signal; and
configuring the memory unit, when the processing unit receives the external display data, to output optical data corresponding to a currently-displaying image in the optical lookup table stored in the memory unit.

10. The operation method according to claim 9, wherein the step of configuring the memory unit to store with one of the plurality of optical lookup table according to the control signal comprises
configuring the memory unit to output the optical data corresponding to a black image.

11. The operation method according to claim 9, wherein the plurality of optical lookup table comprises a plurality of sub-optical lookup table.

12. The operation method according to claim 11, further comprising:
configuring the memory unit to store with one of the plurality of sub-optical lookup table according to the control signal; and
configuring the memory unit, when the processing unit receives the external display data, to output the optical data corresponding to a first portion of the currently-displaying image in the sub-optical lookup table stored in the memory unit and store with another sub-optical lookup table corresponding to a second portion of the currently-displaying image.
